(19) United States
(12) Patent Application Publication
(10) Pub. No.: US 2025/0106678 A1
(43) Pub. Date: Mar. 27, 2025

(54) NETWORK NODE AND METHOD PERFORMED THEREIN

(71) Applicant: Telefonaktiebolaget LM Ericsson (publ), Stockholm (SE)

(72) Inventors: Joachim SACHS, Sollentuna (SE); Marilet DE ANDRADE JARDIM, Kista (SE); Kun WANG, Solna (SE); János FARKAS, Kecskemét (HU)

(21) Appl. No.: 18/291,438

(22) PCT Filed: Jul. 27, 2021
(86) PCT No.: PCT/SE2021/050752

§ 371 Date: Jan. 23, 2024

(51) Int. Cl. H04W 28/02; H04L 47/28; H04W 76/12

(52) U.S. Cl. CPC H04W 28/0268; H04L 47/28; H04W 76/12

(57) ABSTRACT

A method performed by a network node for handling communication in a communication network. The network node sets a UPF node of a 5G system bridge to a status of critical, when a condition is fulfilled. With the proviso that the status of the UPF node is set to critical, network node further constrains a UE to connect to the UPF node.

### TECHNICAL FIELD

Embodiments herein relate to a network node and a method performed therein. Furthermore, a computer program and a computer readable storage medium are also provided herein. In particular, embodiments herein relate to handling interference in a communication network.

### BACKGROUND

In a typical communication network, User Equipment (UE), also known as wireless communication devices, mobile stations, stations (STA) and/or wireless devices, communicate via a Radio Access Network (RAN) to one or more core networks (CNs). The RAN covers a geographical area which is divided into service areas or cell areas, with each service area or cell area being served by a radio network node such as a radio access node e.g., a Wi-Fi access point or a radio base station (RBS), which in some networks may also be denoted, for example, a NodeB, an eNodeB″, or a gNodeB. A service area or cell area is a geographical area where radio coverage is provided by the radio network node. The radio network node communicates over an air interface operating on radio frequencies with the wireless device within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for user equipment. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a variant of a 3GPP radio access technology wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes which can be connected directly to one or more core networks, i.e. they do not need to be connected to the core via RNCs.

With the emerging 5G technologies such as New Radio (NR), the use of a large number of transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify received signals coming from a selected direction or directions, while suppressing received unwanted signals coming from other directions.

A network bridge is a device that can create a single network from different and multiple network segments. In other words, it can connect the two or more networks. Time-Sensitive Networking (TSN) is a set of standards specified by IEEE 802 to enable Ethernet networks to give quality of service, QoS, guarantees for time-sensitive and/or mission-critical traffic and applications.

In a fully centralized configuration model, a Centralized Network Configuration (CNC) can be applied to network devices, e.g. network bridges, and Centralized User Configuration (CUC) can be applied to user devices, e.g. end stations such as UEs. TSN may guarantee the deterministic latency for critical data by various queuing and traffic shaping techniques, such as scheduled traffic (IEEE 802.1 Qbv) and Ethernet frame preemption (IEEE 802.3br and IEEE 802.1 Qbu).

Ultra-reliability is provided by Frame Replication and Elimination for Reliability (FRER) (see IEEE 802.1CB) where data flows are transmitted with multiple copies over disjoint paths in the network. Per-Stream Filtering and Policing (see IEEE 802.1Qci) improves reliability by protecting against bandwidth violation, malfunctioning, and malicious behavior. The generalized Precision Time Protocol (gPTP) (see IEEE 802.1AS) is the TSN tool for time synchronization of network bridges and also end stations.

A 5G system (5GS) comprises a 5G core network and a radio access network. A 5G User Plane Function (UPF) is a gateway to a wireline network, and the radio access network spans over the production plant to provide wireless connectivity to mobile devices. A TSN Translator (TT) function enables interworking between 5G and the wireline TSN network. On the control plane, a 5G bridge provides a management function, e.g. a 5G TSN Application Function (AF) that interacts with a CNC of the TSN network.

The 5GS acts as an Ethernet/TSN bridge towards external Ethernet/TSN networks. All UEs connected to one UPF establish a logical 5GS bridge.

The 5GS bridge reports its capabilities towards a CNC, and it may also report towards other entities via a distributed TSN configuration. Bridge information may include e.g.:
Per-stream filtering and policing (PSFP) information (see IEEE 802.1Q-2018, clause 8.6.5.1);
Time sync information;
Traffic class and traffic forwarding information;
Scheduled traffic information (see Scheduled traffic, IEEE 802.1Q-2018, clause 8.6.8.4); and
Bridge medium access control (MAC) address, number of ports, and for each port its MAC address/port number.

A general assumption in Ethernet/TSN networks is that such capabilities are common to the entire bridge, i.e. they are support on all bridge ports.

For the 5GS bridge, the ports consist of network-side ports implemented at the network-side TSN translator (NW-TT), as well as device-side ports implemented at the device-side TSN translator (DS-TT). The TSN translators in the 5GS architecture, are described in 3GPP, TS 23.501, clause 4.4.8.2. A device-side port gives the TSN connectivity to a UE that is connected to the UPF via a protocol data unit (PDU) session.

The UPF is related to the 3GPP 5GS architecture and supports features and capabilities to facilitate user plane operation. Examples include: packet routing and forwarding, interconnection to the Data Network, policy enforcement and data buffering.

A unique characteristic of a 5GS bridge is that the number of ports is variable. Note that this capability is allowed in IEEE 802.1Q-2018 clause 12.4.2, but it is not common in regular TSN bridges. As new UEs establish connectivity to the UPF for TSN purposes, new bridge ports are created.

A challenge is that different UEs and/or DS-TTs may have different capabilities in TSN/Ethernet support. E.g. some devices may not support 5GS capabilities such as Qbv or PSFP, or certain time sync capabilities or traffic handling capabilities. As these capabilities are reported per bridge, and not per port, the 5GS bridge needs to fall back to the minimum number of capabilities that are supported by all ports, including the UEs'/DS-TTs' ports, as general bridge capability.

As a consequence, a 5GS bridge with many high-capability UEs/DS-TTs may be significantly restricted in its capabilities if only a single low-capability UE/DS-TT is added that supports fewer TSN/Ethernet features, i.e. capabilities. This means that the advanced, e.g. high, capabilities of the majority of UEs/DS-TTs cannot be used due to the limitation of the low-capability device.

Another consequence is that the 5GS bridge capabilities could change over time, depending on which UEs/DS-TTs that are connected to the UPF and their capabilities. E.g. if a low-capability UE/DS-TT is establishing a PDU session to a UPF that already has other devices connected with ongoing communication, the bridge capabilities for those ongoing communications may be changed with the addition of a new UE to the UPF, and the ongoing, possibly critical, communication may need to stop or be reconfigured. E.g. the PSFP, or Qbv, etc. may not be available anymore as configuration option for the bridge.

### SUMMARY

An object of embodiments herein is to provide a mechanism for handling communication in a communication network in an efficient manner.

According to an aspect of embodiments herein the object is achieved by a method performed by a network node for handling communication in a communication network. The network node sets a UPF node of a 5G system bridge, to a status of critical, when a condition is fulfilled. With the proviso that the status of the UPF node is set to critical, the network node constrains a UE to connect to the UPF node.

According to another aspect of embodiments herein, the object is achieved by providing a network node for handling communication in a communication network. The network node is configured to set a UPF node of a 5G system bridge, to a status of critical, when a condition is fulfilled. With the proviso that the status of the UPF node is set to critical, the network node is configured to constrain a UE to connect to the UPF node.

It is furthermore provided herein a computer program comprising instructions, which, when executed on at least one processor, cause the at least one processor to carry out the methods above, as performed by the network node. It is additionally provided herein a computer-readable storage medium, having stored thereon a computer program comprising instructions which, when executed on at least one processor, cause the at least one processor to carry out the methods above, as performed by the network node.

Embodiments herein are based on the realisation that by setting a UPF node of a 5G system bridge to a status of critical, when a condition is fulfilled and constraining a UE to connect to the UPF node when the status of the UPF node is set to critical, the 5GS bridge and its capabilities may be more efficiently used. Consequently, the communication in the communication network is handled in a more efficient manner.

### BRIEF DESCRIPTION OF THE DRAWINGS

Embodiments will now be described in more detail in relation to the enclosed drawings, in which:

FIG. 1 is a schematic overview depicting a communication network according to embodiments herein;

FIG. 2 is a flowchart depicting a method performed by a network node according to embodiments herein;

FIG. 3 is a block diagram depicting a network node according to embodiments herein;

FIG. 4 schematically illustrates a telecommunication network connected via an intermediate network to a host computer;

FIG. 5 is a generalized block diagram of a host computer communicating via a base station with a user equipment over a partially wireless connection; and

FIGS. 6 to 9 are flowcharts illustrating methods implemented in a communication system including a host computer, a base station and a user equipment.

### DETAILED DESCRIPTION

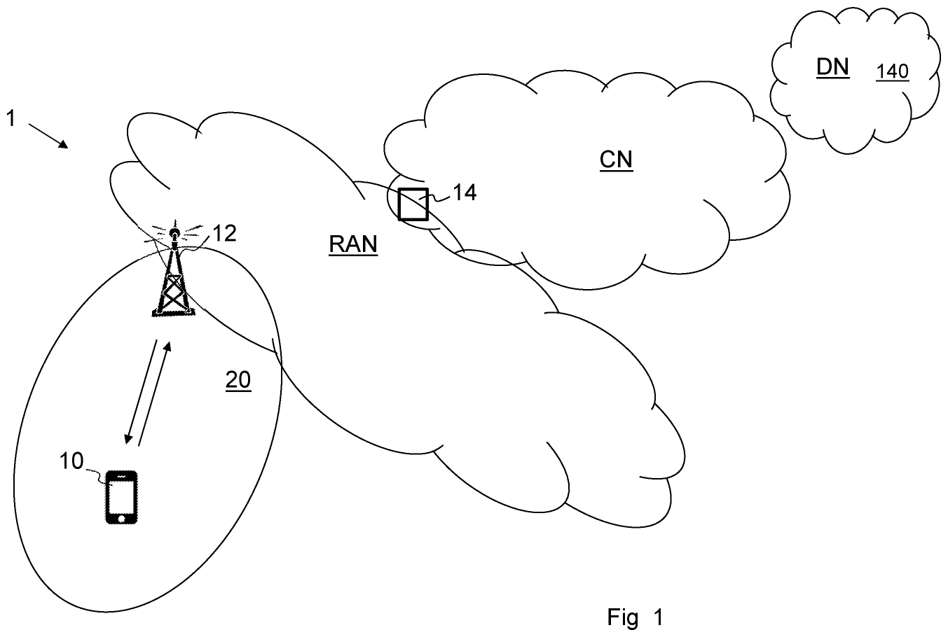

Embodiments herein relate to communication networks in general. FIG. 1 is a schematic overview depicting a communication network 1. The communication network 1 comprises one or more RANs connected to one or more CNs. The communication network 1 may use a number of different technologies, such as Wi-Fi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMAX), or Ultra Mobile Broadband (UMB), just to mention a few possible implementations. Embodiments herein relate to recent technology trends that are of particular interest in a 5G context, however, embodiments are applicable also in further development of the existing communication systems such as e.g. a WCDMA and or LTE system.

In the communication network 1, wireless devices e.g. a UE 10 such as a mobile station, a non-access point (non-AP) station (STA), a STA, a user equipment and/or a wireless terminal, communicate via one or more Access Networks (AN), e.g. RAN, to one or more CNs. It should be understood by the skilled in the art that “UE” is a non-limiting term which means any terminal, wireless communication terminal, user equipment, Machine Type Communication (MTC) device, Device to Device (D2D) terminal, internet of things (IoT) operable device, or node e.g. smart phone, laptop, mobile phone, sensor, relay, mobile tablets or even a small base station capable of communicating using radio communication with a network node within an area served by the network node.

The communication network 1 comprises a network node 12, e.g. a TSN Application Function (AF) node. The network node 12 may also be a radio network node, providing e.g. radio coverage over a geographical area, a first service area 20 i.e. a first cell, of a radio access technology (RAT), such as NR, LTE, Wi-Fi, WiMAX or similar. The network node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The network node 12 may alternatively or additionally be a controller node or a packet processing node or similar. The network node 12 may be referred to as source node, source access node or a serving network node wherein the first service area 20 may be referred to as a serving cell, source cell or primary cell, and the network node communicates with the UE 10 in form of DL transmissions to the UE 10 and UL transmissions from the UE 10. The network node 12 may be a distributed node comprising a baseband unit and one or more remote radio units. It should be noted that a service area may be denoted as cell, beam, beam group or similar to define an area of radio coverage.

A UPF node 14 operates in the CN. The UPF node 14 may support features and capabilities to facilitate user plane operation. Examples may include packet routing and forwarding, interconnection, policy enforcement and data buffering.

According to embodiments herein the network node 12 handles communication in the communication network 1 by setting the UPF node 14 of a 5G system bridge to a status of critical, when a condition is fulfilled and with the proviso that the status of the UPF node 14 is set to critical, the network node 12 constrains the UE 10 to connect to the UPF node 14.

Embodiments herein may be performed by the network node 12. As an alternative, a Distributed Node (DN) and functionality, e.g. comprised in a cloud may be used for performing or partly performing the embodiments herein.

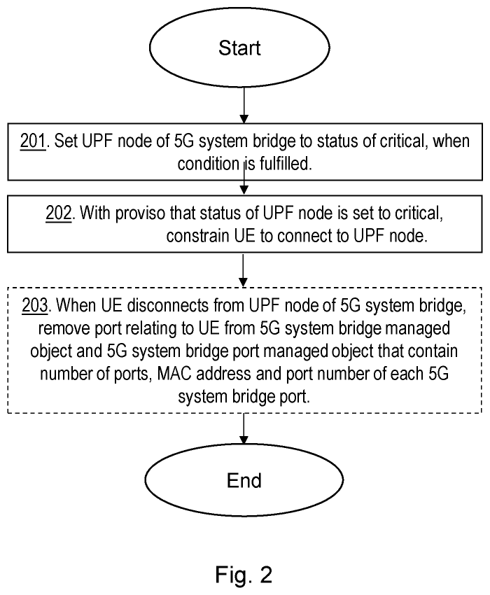

The method actions performed by the network node 12 for handling communication in the communication network 1, according to embodiments herein, will now be described with reference to a flowchart depicted in FIG. 2. The actions do not have to be taken in the order stated below but may be taken in any suitable order. Actions performed in some embodiments are marked with dashed boxes.

Action 201. The 5G system bridge may comprise UEs 10 with high-capability. To enable that the 5G system bridge comprising UEs 10 with high-capability will not be significantly restricted in its capabilities if a UE 10 with low-capabilities is added that supports fewer TSN and/or Ethernet features, the network node 12 first sets the UPF node 14 of the 5G system bridge to the status of critical, when the condition is fulfilled. The condition may be fulfilled in case of one or more of the following conditions are fulfilled:
a number of TSN critical streams that are passing through the UPF node14 of the 5G system bridge exceeds a threshold value;
a number of TSN- and/or Ethernet streams that are passing through the UPF node 14 of the 5G system bridge exceeds a threshold value; and
a number of the UEs 10 that are connected to the UPF node 14 of the 5G system bridge exceeds a threshold value. The UEs 10 that are connected to the UPF node 14 of the 5G system bridge may have demanding QoS flows. The UPF node 14 may be defined such that the different 5G system bridges have different capabilities. The UEs 10 may be connected to the UPF node 14 of the 5G system bridge that matches the capabilities of the UE 10. The capabilities may be reported per port pair, and the 5G system bridge may be configured by assigning traffic streams per port pair. The capabilities for a PSFP may be reported per port, and the port may operate using PSFP independently from the PSFP capabilities of other ports in the same 5G system bridge.

Action 202. With the proviso that the status of the UPF node 14 is set to critical, the network node 12 then constrains the UE 10 to connect to the UPF node 14. I.e., when the status of the UPF node 14 of the 5G system bridge is set to critical, the network node 12 prohibits that new UE 10 ports are created for the UPF node 14, e.g. by directing the UE 10 to another UPF, and, as a consequence, no new UEs 10 are allowed to attach, or establish PDU sessions, to this UPF node 14. According to some embodiments, when the UE 10 is constrained to connect to the UPF node 14, the UE 10 may be directed to another UPF node or to an UPF Virtual Network Function (VNF) instance in the 5G system.

Action 203. When the UE 10 disconnects from the UPF node 14 of the 5G system bridge, the network node 12 may remove a port relating to the UE 10 from a 5G system bridge managed object and a 5G system bridge port managed object that contain a number of ports, a Media Access Control (MAC) address and a port number of each 5G system bridge port. The idea is that once a port related to the UE 10 is removed, the port needs to be removed or the port information from the managed object that an external controller reads needs to be updated. I.e. management information related to such bridge/port is removed/updated.

An advantage of embodiments herein is that the 5G system bridge with high-capability UEs 10 will not be significantly restricted in its capabilities if only a single low-capability UE 10 is added that supports fewer TSN and/or Ethernet features.

Embodiments herein such as mentioned above will now be further described and exemplified. The text below is applicable to and may be combined with any suitable embodiment described above. According to an example scenario, to increase the reliability, the UPF node 14 is declared to a status of “in critical operation”, in case of one or more of the following conditions:
more than yyy TSN streams of high criticality are passing through the UPF node 14;
more than xxx TSN/Ethernet streams are passing through the UPF node 14;
and
more than zzz UEs 10 are connected to the UPF node 14.

Potentially only UEs 10 with demanding QoS flows may be counted.

Once the UPF node 14 is marked as “in critical operation”, it is prohibited that new UE-ports are created for the UPF node 14. As a consequence, no new UEs are allowed to attach, or establish PDU sessions, to this UPF node 14. Instead, UEs 10 may be directed to another UPF node, so that the old UPF can continue its critical operation. In case that the UPF is software-based, a new UPF Virtual Network Function (VNF) may be instantiated for the new traffic. If the UE 10 disappears, e.g. disconnects, from the UPF node 14, the port relating to the UE 10 may be removed from the managed objects, used to report bridge capabilities to a centralized entity, e.g. a CNC, of the bridge and the bridge ports that contain the number of ports and the MAC address and port number of each port.

A UPF may be configured to allow only a limited number of connected devices to avoid that too many UEs 10 are coupled to a common 5GS bridge.

Different UPF nodes 14, each for a different 5GS bridge, may be defined such that the different 5GS bridges have different capabilities, such as:
the 5GS bridge (one per UPF) supporting PSFP,
the 5GS bridge not supporting PSFP, and
the 5GS bridge supporting Qbv.

UEs 10 may be connected to the 5GS bridge (one per UPF node 14) that matches the capabilities of the UE 10 and/or a DS-TT. Note that in the case of PSFP, if the 5GS bridge does not support PSFP, but the UE/DS-TT does support it, then the UE may still connect to the UPF node 14, and the PSFP capabilities in DS-TT are left unused. The UE 10 and/or the DS-TT capabilities may be signaled, or preconfigured.

According to an example, after a PDU session is established, the UE 10 may send a Port Management Information Container (PMIC) to the network node 12, e.g. a TSN Application Function (AF). Before reporting any changes regarding the new port, the TSN AF may verify that the PMIC content matches the supported bridge capabilities by comparing with Bridge Management Information Container (BMIC). If the capabilities, such as support for PSFP, match, or if the UE 10 supports PSFP but the bridge does not support PSFP, in which case the UE 10 would simply not use its capability, then the TSN AF may proceed to report the new port to CNC. Otherwise, the TSN AF may communicate with the 5GC in order to signal a PDU session disconnection and when possible indicate the UE 10 to connect to another UPF that supports the PSFP capability.

In case the UE 10 and/or DS-TT capabilities change, the UE 10 may be redirected to another UPF.

A TSN operation may be changed. Bridge capabilities may be reported to the CNC (or other nodes via distributed configuration) per port pair and the CNC (or distributed configuration agent) may configure the 5G system bridge by assigning traffic streams per port pair and configuring the port capabilities. Configuring the port capabilities may mean setting configuration parameters included in PMIC.

The IEEE PSFP managed object may be modified and set on a per port basis (instead of per bridge), such as it is specified for Qbv. In this case, no agreement of UEs 10 and/or DS-TTs supporting PSFP may be required in the 5GS bridge.

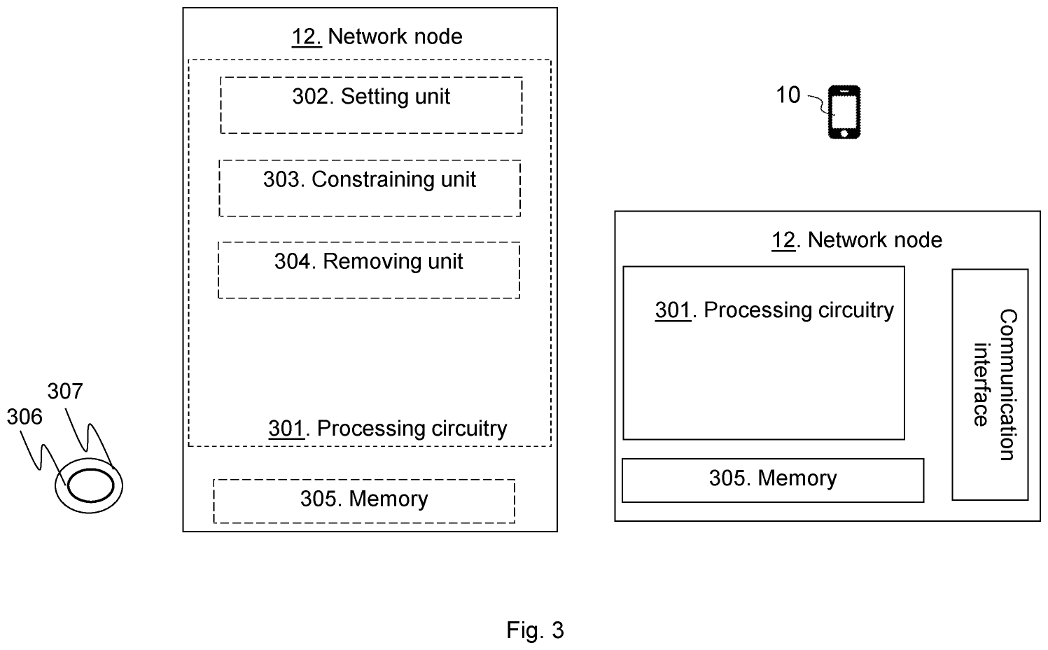

FIG. 3 is a block diagram depicting the network node 12 for handling communication in the communication network 1, according to embodiments herein.

The network node 12 may comprise processing circuitry 301, e.g. one or more processors, configured to perform the methods herein.

The network node 12 may comprise a setting unit 302. The network node 12, the processing circuitry 301, and/or the setting unit 302 is configured to set the UPF node 14 of the 5G system bridge to the status of critical, when the condition is fulfilled. The condition may be fulfilled in case of one or more of the following conditions are fulfilled:
a number of TSN critical streams that are passing through the UPF node14 of the 5G system bridge exceeds a threshold value;
a number of TSN- and/or Ethernet streams that are passing through the UPF node 14 of the 5G system bridge exceeds a threshold value; and
a number of the UEs 10 that are connected to the UPF node 14 of the 5G system bridge exceeds a threshold value. The UEs 10 that are connected to the UPF node 14 of the 5G system bridge may be configured to have demanding QoS flows. The UPF node 14 may be configured to be defined such that the different 5G system bridges have different capabilities. The UEs 10 may be configured to be connected to the UPF node 14 of the 5G system bridge that matches the capabilities of the UE 10. The capabilities may be reported per port pair, and the 5G system bridge may be configured by assigning traffic streams per port pair. The capabilities for a PSFP may be reported per port, and the port may operate using PSFP independently from the PSFP capabilities of other ports in the same 5G system bridge.

The network node 12 may comprise a constraining unit 303. The network node 12, the processing circuitry 301, and/or the constraining unit 303 is configured to constrain the UE 10 to connect to the UPF node 14, with the proviso that the status of the UPF node 14 is set to critical. When the UE 10 is constrained to connect to the UPF node 14, the UE 10 may be configured to be directed to another UPF node or to an UPF Virtual Network Function (VNF) instance in the 5G system.

The network node 12 may comprise a removing unit 304. The network node 12, the processing circuitry 301, and/or the removing unit 304 may be configured to, when the UE 10 disconnects from the UPF node 14 of the 5G system bridge, remove the port relating to the UE 10 from the 5G system bridge managed object and the 5G system bridge port managed object that contain the number of ports, the MAC address, and the port number of each 5G system bridge port.

The network node 12 further comprises a memory 305. The memory 305 comprises one or more units to be used to store data on, such as TSN critical streams, Ethernet streams, QoS flows, input/output data, metadata, etc. and applications to perform the method disclosed herein when being executed, and similar. The network node 12 may further comprise a communication interface comprising e.g. one or more antenna or antenna elements.

The method according to the embodiments described herein for the network node 12 is implemented by means of e.g. a computer program product 306 or a computer program, comprising instructions, i.e., software code portions, which, when executed on at least one processor, cause the at least one processor to carry out the actions described herein, as performed by the network node 12. The computer program product 506 may be stored on a computer-readable storage medium 307, e.g. a disc, a universal serial bus (USB) stick or similar. The computer-readable storage medium 307, having stored thereon the computer program product, may comprise the instructions which, when executed on at least one processor, cause the at least one processor to carry out the actions described herein, as performed by the network node 12. In some embodiments, the computer-readable storage medium may be a transitory or a non-transitory computer-readable storage medium.

In some embodiments the general term “network node” is used and it can correspond to any type of radio-network node or any network node, which communicates with a wireless device and/or with another network node. Examples of network nodes are gNodeB, eNodeB, NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or UE is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any radio access technology (RAT) or multi-RAT systems, where the devices receives and/or transmit signals, e.g. data, such as New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE or network node, for example.

Alternatively, several of the functional elements of the processing units discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Further Extensions and Variations

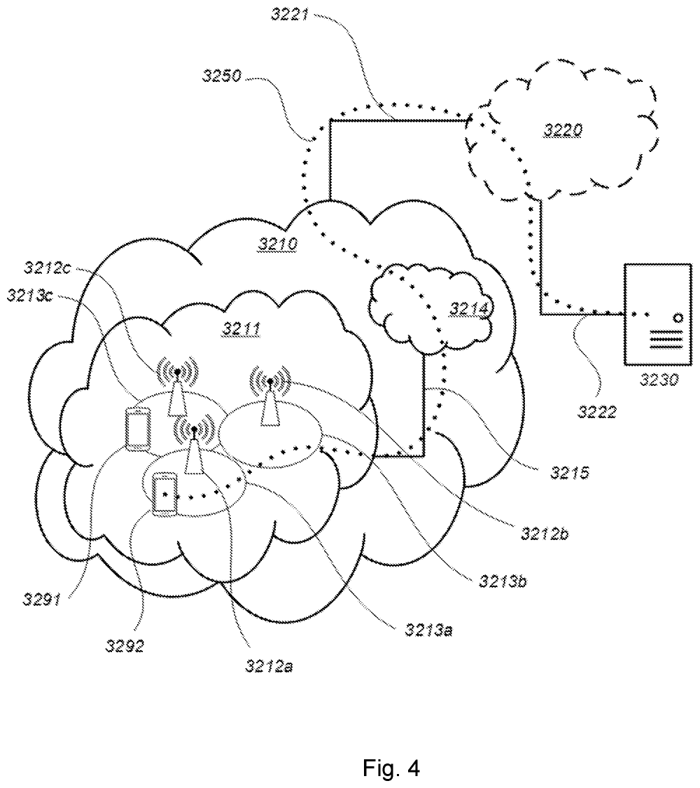

With reference to FIG. 4, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the radio network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless devices 120 such as a non-AP STA 3291 located in coverage area 3213c is configured to wirelessly connect to, or be paged by, the corresponding base station 3212c. A second UE 3292 e.g. the first or second radio node 110, 120 or such as a non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 4 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

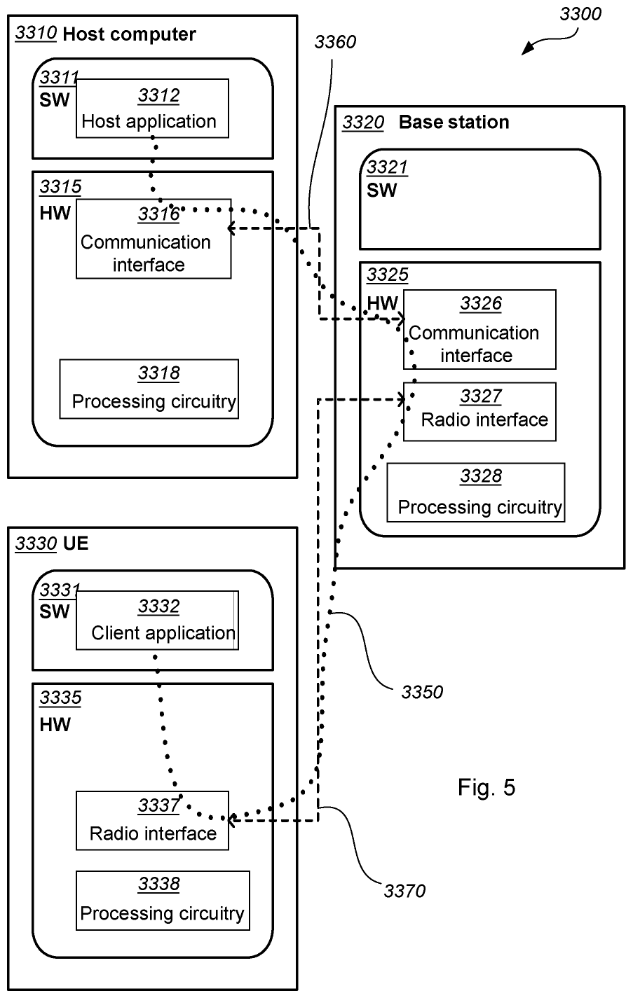

Example implementations, in accordance with an embodiment, of the UE, base station and host computer discussed in the preceding paragraphs will now be described with reference to FIG. 5. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 5) served by the base station 3320. The communication interface 3326 may be configured to facilitate a connection 3360 to the host computer 3310. The connection 3360 may be direct or it may pass through a core network (not shown in FIG. 5) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 5 may be identical to the host computer 3230, one of the base stations 3212a, 3212b, 3212c and one of the UEs 3291, 3292 of FIG. 4, respectively. This is to say, the inner workings of these entities may be as shown in FIG. 5 and independently, the surrounding network topology may be that of FIG. 4.

In FIG. 5, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may handle communication in a communication network in a more efficient and reliable manner and thereby consequently improve the communication in the communication network for the UE. This may also lead to extended battery lifetime of the UE.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

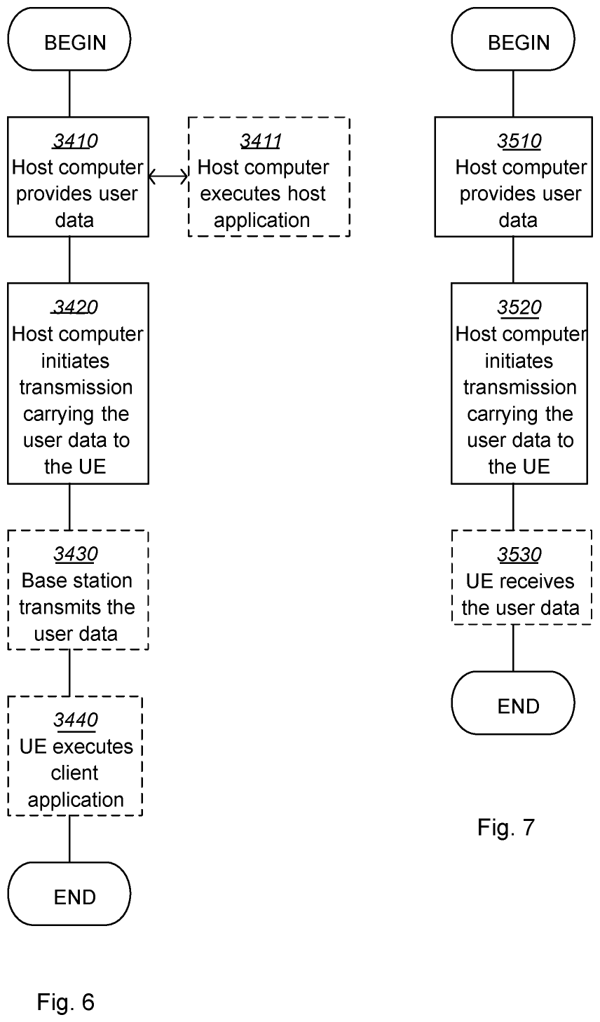

FIG. 6 is a flowchart illustrating a method implemented in a communication system, in accordance with one embodiment. The communication system includes a host computer, a base station such as an AP STA, and a UE such as a non-AP STA which may be those described with reference to FIG. 4 and FIG. 5. For simplicity of the present disclosure, only drawing references to FIG. 6 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 7 is a flowchart illustrating a method implemented in a communication system, in accordance with one embodiment. The communication system includes a host computer, a base station such as an AP STA, and a UE such as a non-AP STA which may be those described with reference to FIG. 4 and FIG. 5. For simplicity of the present disclosure, only drawing references to FIG. 7 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

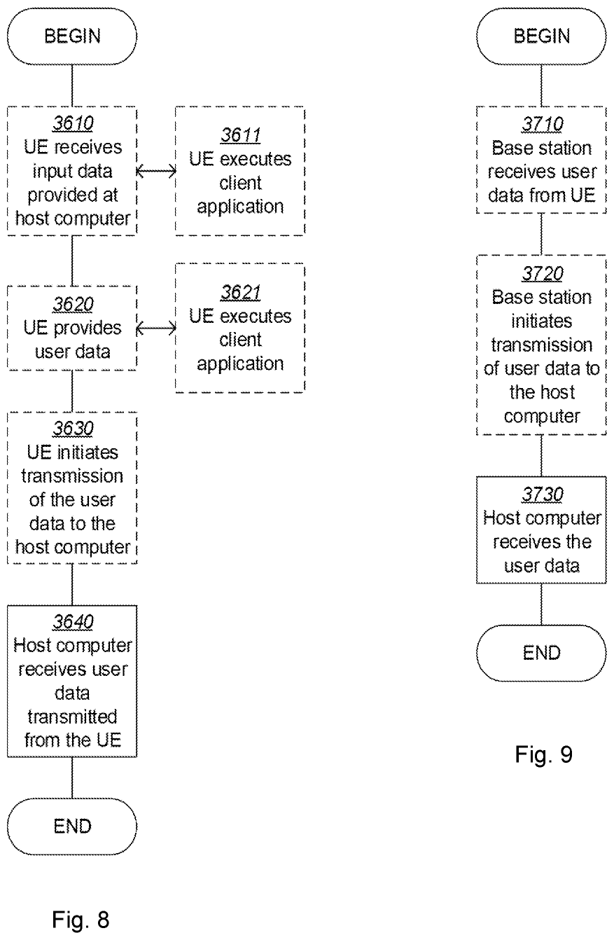

FIG. 8 is a flowchart illustrating a method implemented in a communication system, in accordance with one embodiment. The communication system includes a host computer, a base station such as an AP STA, and a UE such as a non-AP STA which may be those described with reference to FIG. 4 and FIG. 5. For simplicity of the present disclosure, only drawing references to FIG. 8 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station such as an AP STA, and a UE such as a non-AP STA which may be those described with reference to FIG. 4 and FIG. 5. For simplicity of the present disclosure, only drawing references to FIG. 9 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above-described preferred embodiments. Various alternatives, modifications and equivalents may be used.

1. A method performed by a network node for handling communication in a communication network, the method comprising:
setting a User Plane Function, UPF, node of a 5G system bridge, to a status of critical, when a condition is fulfilled; and
with the proviso that the status of the UPF node is set to critical, constraining a User Equipment, UE, to connect to the UPF node.

2. The method according to claim 1, wherein the condition is fulfilled when one or more of the following conditions are fulfilled:
a number of Time-Sensitive Networking, TSN, critical streams that are passing through the UPF node of the 5G system bridge exceeds a threshold value;
a number of TSN- and/or Ethernet streams that are passing through the UPF node of the 5G system bridge exceeds a threshold value; and
a number of the UE that are connected to the UPF node of the 5G system bridge exceeds a threshold value.

3. The method according to claim 1, wherein when the UE is constrained to connect to the UPF node, the UE is directed to another UPF node or to another UPF Virtual Network Function, VNF, instance in a 5G system.

4. The method according to claim 2, wherein the UE that are connected to the UPF node of the 5G system bridge have demanding Quality-of-Service, QoS, flows.

5. The method according to claim 1, wherein the method further comprises:
when the UE disconnects from the UPF node of the 5G system bridge, removing a port relating to the UE from a 5G system bridge managed object and a 5G system bridge port managed object that contain a number of ports, a Media Access Control, MAC, address and a port number of each 5G system bridge port.

6. The method according to claim 1, wherein the UPF node is defined such that the different 5G system bridges have different capabilities.

7. The method according to claim 6, wherein the UE are connected to the UPF node of the 5G system bridge that matches the capabilities of the UE.

8. The method according to claim 1, wherein the capabilities are reported per port pair, and wherein the 5G system bridge is configured by assigning traffic streams per port pair.

9. The method according to claim 1, wherein the capabilities for a Per-Stream Filtering and Policing, PSFP, are reported per port, and wherein the port operates using PSFP independently from the PSFP capabilities of other ports in the same 5G system bridge.

10. A network node for handling communication in a communication network, the network node being configured to:
set a User Plane Function, UPF, node of a 5GS bridge, to a status of critical, when a condition is fulfilled;
with the proviso that the status of the UPF node is set to critical, constrain a User Equipment, UE, to connect to the UPF node.

11.-13. (canceled)

14. The network node according to claim 10, wherein the condition is fulfilled when one or more of the following conditions are fulfilled:
a number of Time-Sensitive Networking, TSN, critical streams that are passing through the UPF node of the 5G system bridge exceeds a threshold value;
a number of TSN- and/or Ethernet streams that are passing through the UPF node of the 5G system bridge exceeds a threshold value; and
a number of the UE that are connected to the UPF node of the 5G system bridge exceeds a threshold value.

15. The network node according to claim 10, wherein when the UE is constrained to connect to the UPF node, the UE is directed to another UPF node or to another UPF Virtual Network Function, VNF, instance in a 5G system.

16. The network node according to claim 14, wherein the UE that are connected to the UPF node of the 5G system bridge have demanding Quality-of-Service, QoS, flows.

17. The network node according to claim 10, wherein the method further comprises:
when the UE disconnects from the UPF node of the 5G system bridge, removing a port relating to the UE from a 5G system bridge managed object and a 5G system bridge port managed object that contain a number of ports, a Media Access Control, MAC, address and a port number of each 5G system bridge port.

18. The network node according to claim 10, wherein the UPF node is defined such that the different 5G system bridges have different capabilities.

19. The network node according to claim 18, wherein the UE are connected to the UPF node of the 5G system bridge that matches the capabilities of the UE.

20. The network node according to claim 10, wherein the capabilities are reported per port pair, and wherein the 5G system bridge is configured by assigning traffic streams per port pair.

21. The network node according to claim 10, wherein the capabilities for a Per-Stream Filtering and Policing, PSFP, are reported per port, and wherein the port operates using PSFP independently from the PSFP capabilities of other ports in the same 5G system bridge.
